(19) United States
(12) Patent Application Publication
(10) Pub. No.: US 2008/0276880 A1
(43) Pub. Date: Nov. 13, 2008

(54) PET SUPPORT SUIT AND METHOD FOR MANUFACTURING THE SAME

(76) Inventors: Eric J. Swisher, Bellingham, WA (US); Victoria L. J. Swisher, Bellingham, WA (US)

Correspondence Address: OSHA LIANG L.L.P., 1221 MCKINNEY STREET, SUITE 2800, HOUSTON, TX, 77010, US

(21) Appl. No.: 12/118,431

(22) Filed: May 9, 2008

Related U.S. Application Data
(60) Provisional application No. 60/928,529, filed on May 10, 2007.

(51) Int. Cl. A01K 15/04; A62B 35/00

(52) U.S. Cl. 119/728; 119/863; 119/856

(57) ABSTRACT

A support suit including support fabric sized to fit around a torso of an animal, where the support fabric includes a bib. The support suit further includes a front girth strap connected to the support fabric and configured to secure the support fabric around a chest portion of the torso, a rear girth strap connected to the support fabric and configured to secure the support fabric around a belly portion of the torso, a first shoulder strap and a second shoulder strap connected to the support fabric and configured to secure the bib to an upper chest portion of the animal, where the first shoulder strap is located on a right side of a neck of the animal and wherein the second shoulder strap is located on the left side of the neck, and a bridge strap configured to fix a distance between the first shoulder strap and the second shoulder strap.

### CROSS-REFERENCE TO RELATED APPLICATIONS

This application claims priority, pursuant to 35 U.S.C. § 119(e), to the filing date of U.S. Patent Application Ser. No. 60/928,529, entitled “Pet Support Suit and Method for Manufacturing The Same,” filed on May 10, 2007, which is hereby incorporated by reference in its entirety.

### BACKGROUND

Animals such as dogs get involved in accidents that render them immobile and disabled. Additionally, pets also suffer from temporary immobility in the aftermath of an illness or a recent surgery. These necessitate a support harness for carrying them to desired locations or aiding in their movement towards the desired locations.

Typical harness solutions include support slings for either one of the frontal portion or the rear portion of an animal. Therefore, these slings are two-piece combinations that support each end of the animal separately, whereby an unbalanced or faulty strapping could cause excruciating pain to the animal.

### SUMMARY

In general, in one aspect, the invention relates to a support suit. The support suit includes a support fabric sized to fit around a torso of an animal, wherein the support fabric comprises a bib and wherein the torso of the animal is approximately located between a front leg and a rear leg of the animal, a front girth strap connected to the support fabric and configured to secure the support fabric around a chest portion of the torso, a rear girth strap connected to the support fabric and configured to secure the support fabric around a belly portion of the torso, a first shoulder strap and a second shoulder strap connected to the support fabric and configured to secure the bib to an upper chest portion of the animal, wherein the first shoulder strap is located on a right side of a neck of the animal and wherein the second shoulder strap is located on the left side of the neck, and a bridge strap configured to fix a distance between the first shoulder strap and the second shoulder strap.

In general, in one aspect, the invention relates to a support suit, that includes a front edge and a back edge, wherein the distance between the front edge and back edge corresponds to a body length of an animal, a first side edge and a second side edge, wherein the first side edge and the second side edge are configured to connect on a back portion of the animal, such that the support suit is secured around a torso of the animal, a bib extending from the front edge and sized to fit between a first foreleg and a second foreleg of the animal, a first shoulder strap and a second shoulder strap configured to secure the bib to an upper chest portion of the animal, and a bridge strap configured to fix a distance between the first shoulder strap and the second shoulder strap.

In general, in one aspect, the invention relates to a method for manufacturing a support suit. The method includes obtaining a chest circumference of an animal, obtaining a belly circumference of the animal, obtaining a body length of the animal, determining a size, a taper, and a length of the support suit using the chest circumference, the belly circumference, and the body length, and creating the support suit based on the size, taper, and length. The support suit includes support fabric sized to fit around a torso of the animal, wherein the support fabric comprises a bib and wherein the torso of the animal is approximately located between a front leg and a rear leg of the animal, a front girth strap connected to the support fabric and configured to secure the support fabric around a chest portion of the torso, a rear girth strap connected to the support fabric and configured to secure the support fabric around a belly portion of the torso, a first shoulder strap and a second shoulder strap connected to the support fabric and configured to secure the bib to an upper chest portion of the animal, wherein the first shoulder strap is located on a right side of a neck of the animal and wherein the second shoulder strap is located on the left side of the neck, and a bridge strap configured to fix a distance between the first shoulder strap and the second shoulder strap.

Other aspects of the invention will be apparent from the following description and the appended claims.

### BRIEF DESCRIPTION OF DRAWINGS

FIG. 1 shows a top-view schematic diagram of a support suit in accordance with one embodiment of the invention.

FIGS. 2-4 shows a perspective view of the support suit shown in FIG. 1 in accordance with one embodiment of the invention.

FIGS. 5 and 6 show schematic diagrams for determining taper in a support suit in accordance with one or more embodiments of the invention.

FIGS. 7A-7D show schematic diagrams for designing a taper in accordance with one embodiment of the invention.

FIG. 8 shows a top-view schematic diagram of a support suit in accordance with one embodiment of the invention.

FIG. 9 shows a perspective view of the support suit in accordance with one embodiment of the invention.

FIG. 10 shows a front view of the support suit in accordance with one embodiment of the invention.

FIG. 11 shows a front view of the support suit in accordance with one embodiment of the invention.

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a one-piece support suit. In one or more embodiments of the invention, the support suit is designed to account for the animal's body balance and size, ease of attachment to animal's body and subsequent detachment, security of attachment/detachment, and/or quickness of the attachment/detachment process. In one embodiment of the invention, the support suit may be used on any animal that has front and rear legs. Examples of animals include, but are not limited to, dogs, and cats.

Various exemplary embodiments of the invention will now be described with reference to the accompanying figures. Like elements are referred to by like reference numerals in the several views for the sake of clarity.

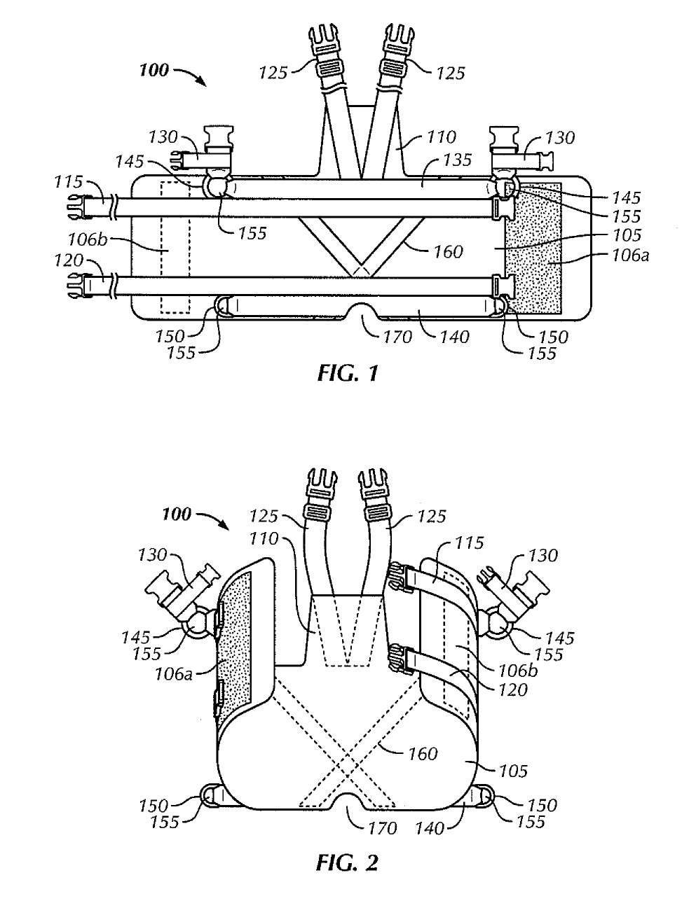

FIG. 1 shows a support suit in accordance with one embodiment of the invention. The support suit 100 includes a support fabric 105 extending in a horizontal direction. In one embodiment of the invention, the support fabric 105 is layered. The support fabric 105 has a bib 110 on a side extending perpendicular to the horizontal direction. The bib 110 is configured to cover a portion of the animal's chest and therefore, could be padded in order to mitigate the pressure at the animal's chest upon completion of attachment and subsequent lifting up of the animal. A front girth strap 115 is connected to the support fabric 105 at an end closer to the bib 110 in order to secure the support fabric 105 around the chest portion of the animal's torso. Similarly, a rear girth strap 120 is connected to the support fabric 105 at an end farther from the bib 110 in order to secure the support fabric 105 around the belly portion of the animal's torso.

Around the region of the bib 110, a pair of shoulder straps 125 are connected to the support fabric 105 and are configured to secure the bib 110 to the upper chest portion of the animal. Each one of the pair of shoulder straps 125 is configured to be positioned on either side of the animal's torso near the neck region. The support suit 100 may further include securing means (106a, 106b) such as Velcro® at either end of the support fabric 105, whereby the two ends secure each other via the securing means in a folded state of the support fabric 105 over the animal's torso. (Velcro is a registered trademark of Velcro Industries B.V.). Additionally, the support suit 100 further includes a bridge strap 130 configured to fix a distance between each of the shoulder straps 125 in the secured state of the support suit 100 over the animal's torso. The presence of the bridge strap 130 ensures that the shoulder straps 125 are held securely together and that the support suit 100 is centered on the animal's torso. In one embodiment of the invention, the support suit 100 is centered on the animal when the centerline of the support suit is approximately parallel to a backbone of the animal

Further, the support suit 100 includes a front support strap 135 that is closer to the bib 110 in an unfolded state of the support suit 100, and a rear support strap 140 that is farther from the bib 110 in an unfolded state of the support suit 100. Once the support suit 100 is folded over the animal's torso, a pair of rings 145 attached to the support fabric 105, the bridge strap 130, and the front support strap 135 along with a pair of rings 150 attached to the support fabric 105 and the rear support strap 140 form lifting points 155 of the support suit 100. Once the support suit 100 is secured to the animal's torso, additional straps may be connected to these lifting points 155 to carry the animal to desired locations or aiding in their movement towards the desired locations. In one embodiment of the invention, the rings 145 are O-rings and 150 are D-rings.

In one embodiment of the invention, the support suit 100 may also include an “X-belly” strap 160 configured to crisscross over the belly of the animal. As shown in FIG. 1, the “X-belly” strap 160 may be connected between the front support strap 135 and the rear support strap 140 in order to keep the support suit 100 secure in a folded state over the animal's torso. Further, the X-belly strap 160 facilitates lifting of the animal in the support suit 100 by distributing the force from the lift points. In one embodiment of the invention, each of the straps which make up with “X-belly” strap 160 are placed at ˜45 degree angles relative to the front and back edges of the support suit 100 and at ˜90 degrees to each other.

An abdominal cut-out 170 in a semi-circular shape, as an example, is also shown. One of ordinary skill in the art will appreciate that securing means other than Velcro®, relative positions of the bib and straps, lifting point 155 configurations, abdominal cut-out shapes etc. would involve mere modifications of the embodiment described in FIG. 1 and are well within the scope of the invention. Further, in the embodiment shown in FIG. 1, numerous specific details are set forth in order to provide a thorough understanding of the invention. It will also be apparent to one of ordinary skill in the art that the invention may be practiced without these specific details.

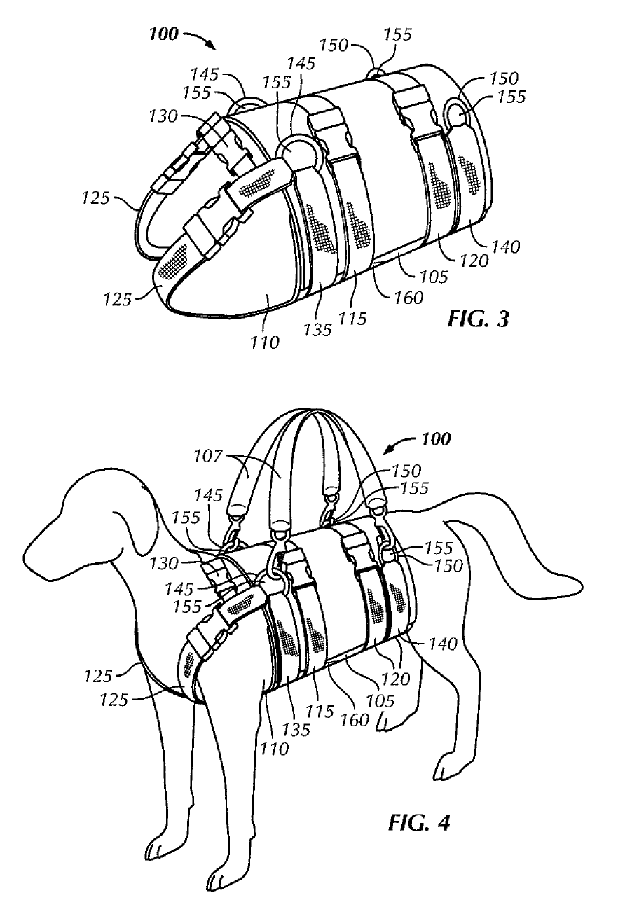

FIG. 2 shows a folded perspective view of the embodiment of the support suit shown in FIG. 1 and described above. The flat portion of the support fabric 105 is an inside of the support suit 100 in a folded state. FIG. 2 demonstrates how the support suit 100 may be attached onto an injured animal, e.g., the wrapping of the support fabric 105 over the belly of the animal, securing harness with securing means, and strapping all the described elements so that the support suit 100 is securely held onto the torso of the animal.

FIG. 3 is a perspective view of the embodiment of the support suit shown in FIG. 1 in a state of attachment. The edges of flaps of the support fabric 105, secured to each other through securing means, are shown along with additional straps for lifting the animal in an upward direction for ease of translation. The animal's torso is shown without the head and limbs to demonstrate key aspects of the invention.

FIG. 4 is a perspective view of the embodiment of the support suit shown in FIG. 1 secured to an animal. As shown in FIG. 4, one or more handles 107 may be connected to the lifting points 155 in order to aid the animal to move toward the desired location or carry the animal to the desired location. In one embodiment of the invention, the handles 107 are removable and may be used by one or more people to carry or aid the animal in moving to the desired location.

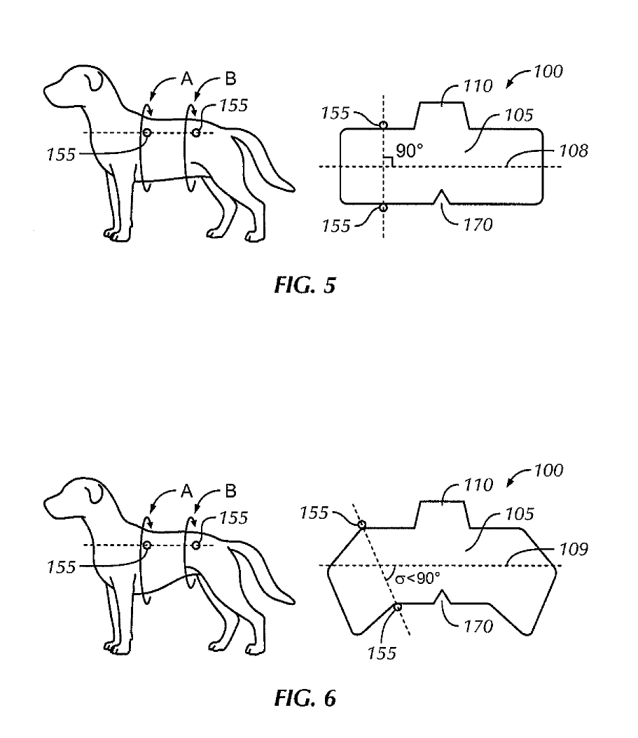

In one or more embodiments of the invention, design considerations of the embodiment of the support suit 100 take into account chest and belly circumferences of the animal. The difference between the chest circumference (A in FIGS. 5 and 6) and belly circumference (B in FIGS. 5 and 6) is referred to as “body taper.” FIG. 5 shows an animal, on whose body there are two lifting point 155 locations. The non-tapered body on the animal, i.e., same chest circumference and belly circumference, translates to the two lifting points 155 being on a line 108 exactly perpendicular to a length of the support fabric 105 of the support suit 100 as shown in FIG. 5.

FIG. 6 shows an animal whose chest circumference (A) is larger than the belly circumference (B). This translates to the lifting points 155 on the support suit being at an angle (σ) with respect a line 109 along the length of the support fabric 105 of the support suit 100 as shown in FIG. 6. Therefore, the body portion of the support suit 100 is reduced at the belly end compared to the body portion at the chest end. Additionally, an increase in girth corresponding to an increase in circumference of the animal's chest necessitates a reduction of the flap section at the belly end compared to the flap section at the chest end as shown in FIG. 6.

In one embodiment of the invention, three measurements from the animal are obtained: (i) chest circumference (e.g., A in FIGS. 5 and 6), (ii) the belly circumference (e.g., B in FIGS. 5 and 6), and (iii) length of the animal's torso (e.g., distance between the front leg and the rear leg of the animal). The following is a method for determining the appropriate sizing for a support suit 100 using the above measurements in accordance with one embodiment of the invention.

In one embodiment of the invention, a support suit may be sized to an animal based on an x-y-z code, where x, y, and z are described below. x is ˜⅔ of the chest circumference of the animal. y is the difference between the animal's chest circumference and the animal's belly circumference. z is ˜90% of the measured body length of the animal.

The following is an example of generating the x-y-z code for a support suit and is not intended to limit the scope of the invention. For the purposes of this example, assume that the animal has a chest circumference of 31″, a belly circumference of 25″, and a body length of 15″. Based on these measurements, x=20″ (˜⅔ of 31″), y=6″ (31″−25″), z=13.5″ (˜90% of 15″). Based on the above, the x-y-z code for the support suit is 20-6-13.5. In one embodiment of the invention, the value of x is determined to allow for a range of fit for the animal. Further, the value of z is determined to allow for the animal's sitting and leg movement.

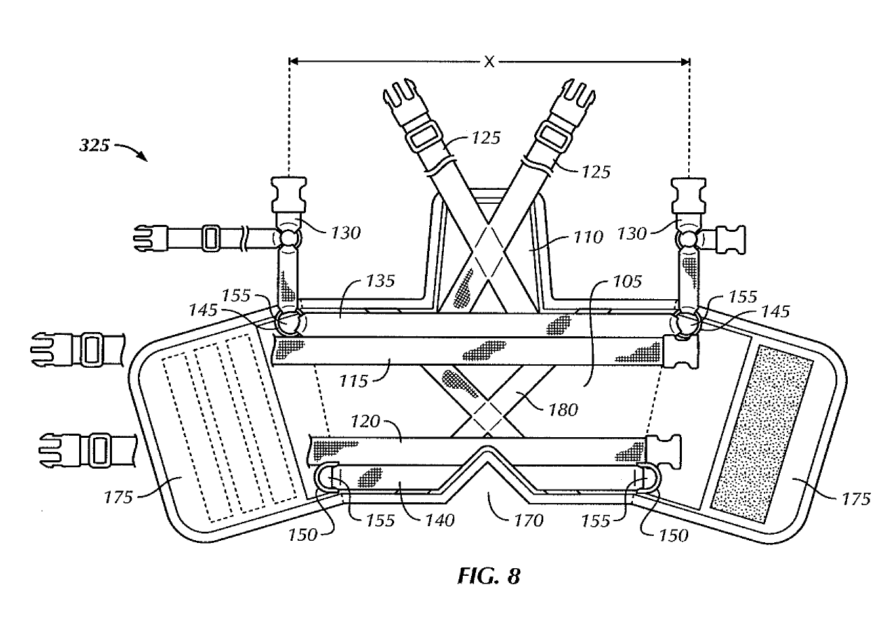

Using the x-y-z code, the support suit may be designed. With reference to FIGS. 1 and 8, in one embodiment of the invention, the bib 110 is designed based on the x value. Specifically, the base of the bib 110 is sized at ˜30% of x. In one embodiment of the invention, the base of the bib 110 is the edge of the bib 110 which is flush with the front support strap 135. The length of the bib 110 is sized at ˜30% of x, and the width of the bib 110 is sized at ˜25% of x. In one embodiment of the invention, the corners may be rounded. In one embodiment of the invention, the bib 110 may include shoulder straps in V-shaped configuration (see FIG. 1) or shoulder straps in an X-shaped configuration (see FIG. 8). In one embodiment of the invention, the shoulder straps in the X-shaped configuration cross at the approximate center of the bib 110. In one embodiment of the invention, the X-shaped configuration broadens the angle at the throat where the shoulder straps diverge, providing additional space around the throat. In the V-shaped configuration, the shoulder straps meet at the base of the bib 110. The X on the chest also mirrors the X of the belly straps.

With respect to the abdominal cut 170, in one embodiment of the invention, the abdominal cut-out 170 in the support suit 100 is shown as a right-isosceles triangle shape. In one embodiment of the invention, the triangle shape may eliminate the necessity to fold the fabric corners in a semi-circular shape case into small flaps. Typically, the height of the abdominal cut-out 170 is sized at ˜25% of z.

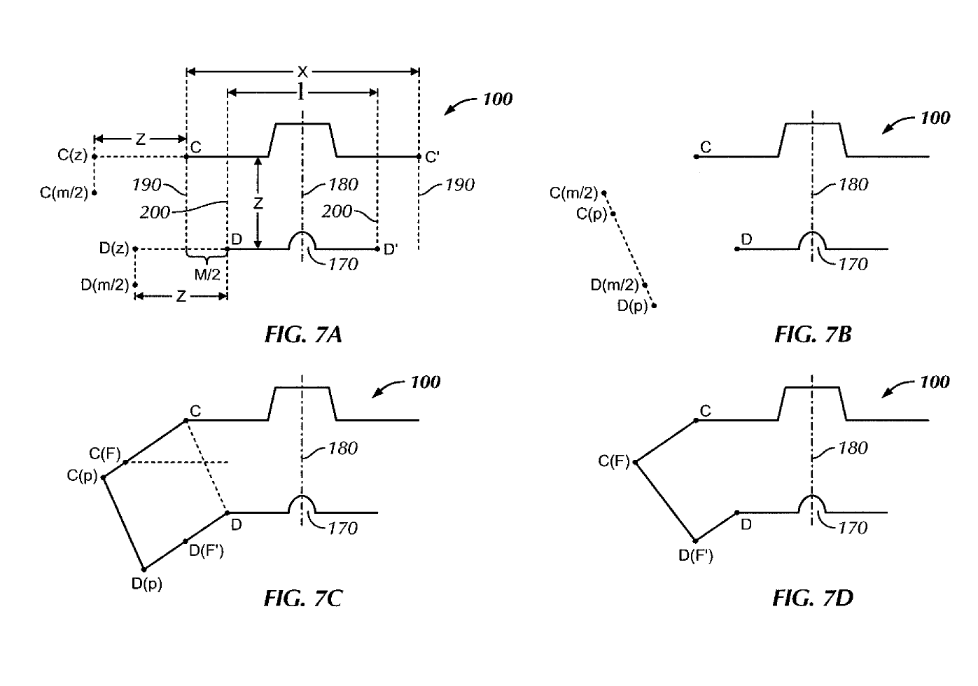

In one embodiment of the invention, y is used to modify the flap length and the body length. More specifically, in one embodiment of the invention, each flap is reduced by ⅙y and the rear edge width of the support suit is reduced by ⅔y to obtain the rear edge D-D′ (see FIG. 7A). From the above example, if y=6″, then the length of each flap is reduced by 1″ and the rear edge width of the support suit is reduced by 4″ (2″ on each side of the centerline 180 along with rear edge.

The following discussion describes how the taper for the support suit is designed in accordance with one embodiment of the invention. Referring to FIGS. 7A-7D, in order to design the taper the following measurement lengths are taken into consideration: x—distance between the front support rings 145 (as discussed x˜⅔ A), z—body length of the suit, l—scaled value of the belly circumference (e.g., ˜⅔ of B), and m—difference between x and l.

Using the above measurement lengths, the taper may be determined as follows. Referring to FIG. 7A, the center line of the suit 180 is marked along with the distances of x and l around the center-line (denoted by the pairs of lines 190 and 200 and marked by C-C′, and D-D′). The distance between an individual line 190 and the closest individual line 200 is m/2. The points on the plane where measurements of A and B are made are translated, i.e., C and D, by z and marked as points C(z) and D(z). C(z) and D(z) are then translated downward by a distance m/2, and marked as points C(m/2) and D(m/2) (see FIG. 7A). C(m/2) and D(m/2) are then joined by a line as shown in FIG. 7B.

Flap length is then calculated using x to obtain flap-length (F) (e.g., F˜50% x) and using 1 to obtain flap-length (F′) (e.g., F′˜50% l). A value for p is then calculated by determining the difference between F and F′. A point C(p) is located at distance p from C(m/2) on the line connecting C(m/2) and D(m/2). A point D(p) is located at distance p from D(m/2) on the line connecting C(m/2) and D(m/2).

Referring to FIG. 7C, a line is drawn from C passing through C(p), and a line is drawn from D passing through D(p). A distance F is measured from C on the line C-C(p) and marked as C(F). A distance F′ is measured from D on the line D-D(p) and marked as D(F′). A line is drawn connecting C(F) and D(F′). The line C(F)-D(F′) is the flap-edge (see FIGS. 7C-7D).

Those skilled in the art will appreciate that any of the aforementioned dimensions may be modified at a customer's request.

FIG. 8 shows a tapered support suit in accordance with one embodiment of the invention. As discussed above, the distance x between the front support rings 145 is sized at ˜⅔ of the chest circumference. The ends of the shoulder straps 125 are crossed into an X-shaped configuration at the approximate center of the bib 110.

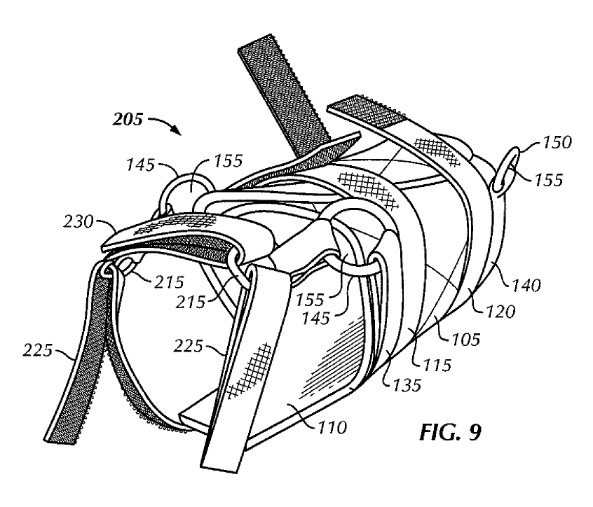

In one embodiment of the invention, when the need arises to design smaller support suits, buckles may not be employed as the securing means. Rather, referring to FIG. 9, the support suit 205 includes hook and loop closures (e.g., Velco®) to secure the various straps in the support suit in place. The support suit 205 also includes bridge strap rings 215 to connect the shoulder straps 225 and the bridge strap 230. In one embodiment of the invention, the rings 215 are D-rings.

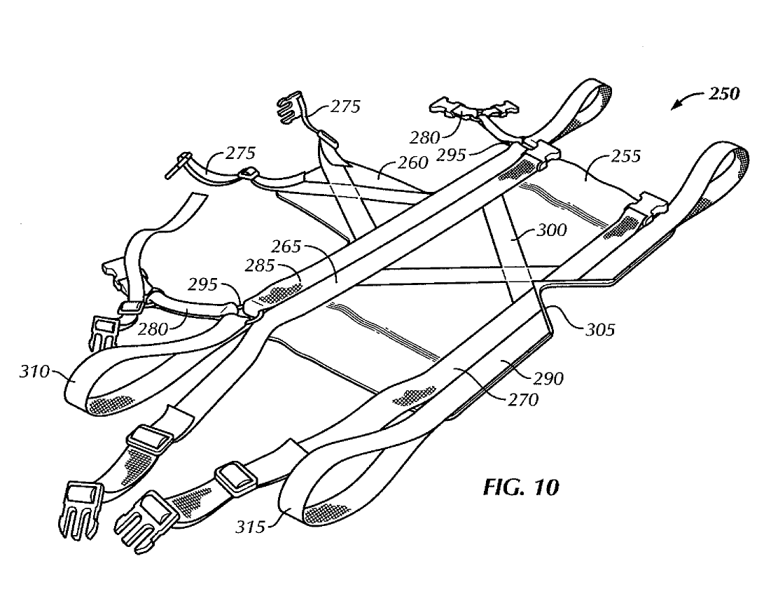

In one embodiment of the invention, the support suit may be modified to enable easier mass-production. FIG. 10 shows such a modified support suit in accordance with one embodiment of the invention. The support suit 250 includes a support fabric 255 extending in a horizontal direction. The support fabric 255 has a bib 260 on a side extending perpendicular to the horizontal direction. The bib 260 is configured to cover a portion of the animal's chest and therefore, could be padded in order to mitigate the pressure at the animal's chest upon completion of attachment and subsequent lifting up of the animal. A front girth strap 265 is connected to the support fabric 255 at an end closer to the bib 260 in order to secure the support fabric 255 around the chest portion of the animal's torso. Similarly, a rear girth strap 270 is connected to the support fabric 255 at an end farther from the bib 260 in order to secure the support fabric 255 around the belly portion of the animal's torso.

Around the region of the bib 260, a pair of shoulder straps 275 are connected to the support fabric 255 and are configured to secure the bib 260 to the upper chest portion of the animal. Each one of the pair of shoulder straps 275 is configured to be positioned on either side of the animal's torso near the neck region. Additionally, the support suit 250 further includes a bridge strap 280 configured to fix a distance between each of the shoulder straps 275 in the secured state of the support suit 250 over the animal's torso. The presence of the bridge strap 280 ensures that the shoulder straps 275 are held securely together and that the support suit 250 is centered on the animal's torso.

Further, the support suit 250 includes a front support strap 285 that is closer to the bib 260 in an unfolded state of the support suit 250, and a rear support strap 290 that is farther from the bib 260 in an unfolded state of the support suit 250. Once the support suit 250 is folded over the animal's torso, a pair of rings 295 attached to the support fabric 255, the bridge strap 280, and the front support strap 285 forms lifting points of the support suit 250. In one embodiment of the invention, the rings 295 are O-rings. At the end farther away from the bib 260, there arc no rings employed. In one embodiment of the invention, unlike the support suit shown in FIG. 1, the modified support suit 250 does not include overlapping flaps.

As shown in FIG. 10, the rings 295 are connected to handles 310. Further, the rear support strap 290 includes a rear handle 315 which is contiguous with the rear support strap 290. In another embodiment of the invention, the rear support strap 290 may be affixed to rings (similar to those in FIG. 1). In such cases, handles may be attached to these rings.

In one embodiment of the invention, the taper in the modified support suit 250 may be determined based on the relative size of the animal: small (8″ body length), medium (11″ body length), and large (13″ body length). The taper for large and medium sized animals is a 3″ reduction (measured from the back edge of the support suit) off of the length of the support suit while for small animals the taper is a 2″ reduction (measured from the back edge of the support suit) off of the length of the support suit.

In one embodiment of the invention, the support suit 250 may also include an “X-belly” strap 300 configured to crisscross over the belly of the animal. As shown in FIG. 10, the “X-belly” strap 300 may be connected between the front support strap 285 and the rear support strap 290 in order to keep the support suit 250 secure in a folded state over the animal's torso. In one embodiment of the invention, each of the straps which make up with “X-belly” strap 300 are placed at ˜45 degree angles relative to the front and back edges of the support suit 250 and at ˜90 degrees to each other. Further, the X-belly strap 300 facilitates lifting of the animal in the support suit 100 by distributing the force from the lift points. An abdominal cut-out 305 in a triangular shape, as an example, is also shown.

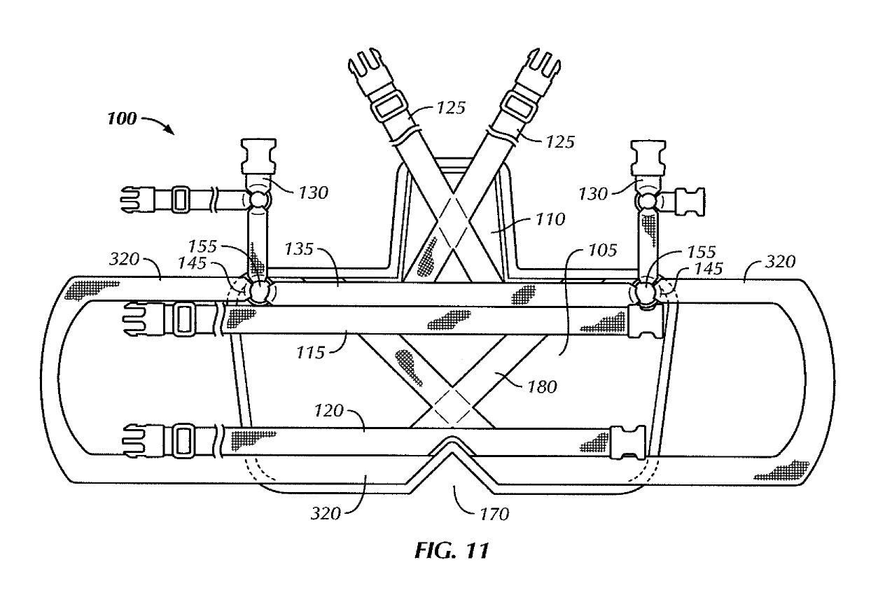

FIG. 11 shows a support suit in another embodiment of the invention. Similar to FIG. 10, the support suit shown in FIG. 11 is designed for ease of mass-production. Unlike the support suit 250 shown in FIG. 10, the support suit 325 shown in FIG. 11 includes a contiguous handle 320. As shown in FIG. 11, a portion of the handle 320 functions as the rear support strap 140 shown in FIG. 8. The remainder of the handle 320 allows the user's to lift the animal.

In one or more embodiments of the invention, the pain caused to the animal owing to typical two-piece support suit solutions is considerably reduced by the one-piece solution. Further, in one or more embodiments of the invention, attachment/detachment of the support suit is easier than typical solutions, and also does not require extensive manipulation of the torso, head or legs of the animal during attachment or detachment of the support suit. More specifically, in one or more embodiments of the invention, the support suit may be attached onto an animal while it is in a lying state. In addition, in one or more embodiments of the invention, the support suit does not require any portion to go over the animal's head, thereby allowing for attachment of the support suit onto the animal even when a collar is attached to the neck of the animal. Additionally, in one or more embodiments of the invention, the design of the support suit accounts for varying sizes and shapes of animals. Further, in one or more embodiments of the invention, the support suit allows for ease of movement of the animal.

While the invention has been described with respect to an exemplary embodiment, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A support suit, comprising:
support fabric sized to fit around a torso of an animal, wherein the support fabric comprises a bib and wherein the torso of the animal is approximately located between a front leg and a rear leg of the animal;
a front girth strap connected to the support fabric and configured to secure the support fabric around a chest portion of the torso;
a rear girth strap connected to the support fabric and configured to secure the support fabric around a belly portion of the torso;
a first shoulder strap and a second shoulder strap connected to the support fabric and configured to secure the bib to an upper chest portion of the animal, wherein the first shoulder strap is located on a right side of a neck of the animal and wherein the second shoulder strap is located on the left side of the neck; and
a bridge strap configured to fix a distance between the first shoulder strap and the second shoulder strap.

2. The support suit of claim 1, further comprising:
a first front lift point located at an intersection of the first shoulder strap and a front support strap;
a second front lift point located at an intersection of the second shoulder strap and the front support strap;
a first rear lift point on a rear support strap, wherein the first rear lift point is located on the right side of the torso; and
a second rear lift point on the rear support strap, wherein the second rear lift point is located on the left side of the torso.

3. The support suit of claim 1, wherein the support suit further comprises:
a first belly strap connected to the support fabric, wherein a first end of the first belly strap is connected to a front support strap and a second end of the first belly strap is connected a point of on the left side of the torso on a rear support strap; and
a second belly strap connected to the support fabric, wherein a first end of the second belly strap is connected to the front support strap and a second end of the second belly strap is connected a point of on the right side of the torso on the rear support strap.

4. The support suit of claim 1, wherein the support fabric is tapered based on a shape of the torso of the animal.

5. The support suit of claim 1, wherein the support fabric comprises a hook and loop connector material to secure the support fabric to the torso.

6. The support suit of claim 1, wherein the bridge strap is adjustable.

7. The support suit of claim 1, wherein the bridge strap is configured to maintain the support suit approximately along a centerline of the animal and wherein the centerline of the animal is approximately parallel to a backbone of the animal.

8. The support suit of claim 1, wherein the bib is sized to fit between a first foreleg and a second foreleg of the animal.

9. The support suit of claim 1, wherein the support fabric is a layered fabric.

10. The support suit of claim 1, wherein the animal is a dog.

11. A support suit, comprising:
a front edge and a back edge, wherein the distance between the front edge and back edge corresponds to a body length of an animal;
a first side edge and a second side edge, wherein the first side edge and the second side edge are configured to connect on a back portion of the animal, such that the support suit is secured around a torso of the animal;
a bib extending from the front edge and sized to fit between a first foreleg and a second foreleg of the animal,
a first shoulder strap and a second shoulder strap configured to secure the bib to an upper chest portion of the animal; and
a bridge strap configured to fix a distance between the first shoulder strap and the second shoulder strap.

12. The support suit of claim 11, further comprising:
two lift points located along the front edge; and
two lift points located along the back edge.

13. The support suit of claim 11, wherein the back edge comprises an abdominal cutout.

14. The support suit of claim 11, wherein the front edge is tapered.

15. The support suit of claim 14, wherein the front edge is tapered based on a shape of the torso of the animal.

16. The support suit of claim 11, wherein the back edge is tapered.

17. The support suit of claim 16, wherein the front edge is tapered based on the shape of the torso of the animal.

18. The support suit of claim 11, wherein the first side edge and the second side edge are configured to connect using a Velcro® strip.

19. The support suit of claim 11, wherein the bridge strap is adjustable.

20. A method for manufacturing a support suit, comprising:
obtaining a chest circumference of an animal;
obtaining a belly circumference of the animal;
obtaining a body length of the animal;
determining a size, a taper, and a length of the support suit using the chest circumference, the belly circumference, and the body length; and
creating the support suit based on the size, taper, and length, wherein the support suit comprises:
support fabric sized to fit around a torso of the animal, wherein the support fabric comprises a bib and wherein the torso of the animal is approximately located between a front leg and a rear leg of the animal;
a front girth strap connected to the support fabric and configured to secure the support fabric around a chest portion of the torso;
a rear girth strap connected to the support fabric and configured to secure the support fabric around a belly portion of the torso;
a first shoulder strap and a second shoulder strap connected to the support fabric and configured to secure the bib to an upper chest portion of the animal, wherein the first shoulder strap is located on a right side of a neck of the animal and wherein the second shoulder strap is located on the left side of the neck; and
a bridge strap configured to fix a distance between the first shoulder strap and the second shoulder strap.
